(19) United States
(12) Patent Application Publication
(10) Pub. No.: US 2018/0181912 A1
(43) Pub. Date: Jun. 28, 2018

(54) Verifying the Authenticity of the Content of Consignments

(71) Applicants: Christian Ibach, Bonn (DE); Ralph Wiechers, Mayschoss (DE)

(72) Inventors: Christian Ibach, Bonn (DE); Ralph Wiechers, Mayschoss (DE)

(73) Assignee: Deutsche Post AG, Bonn (DE)

(21) Appl. No.: 15/852,142

(22) Filed: Dec. 22, 2017

(30) Foreign Application Priority Data
Dec. 22, 2016 (DE) 10 2016 125 503.3

(51) Int. Cl. G06Q 10/08

(52) U.S. Cl. CPC G06Q 10/0838

(57) ABSTRACT

In embodiments of a method, data of a consignment is gathered, or such data is obtained. The consignment is provided with at least one piece of information that enables determining of plausibility information indicative of a content to be authenticated of the consignment. Data representing the content of the consignment is gathered, or such data is obtained. A piece of authenticating information is generated, or the determined plausibility information and the gathered data representing the content of the consignment are output for generating such authenticating information. The authenticating information indicates the authenticity of the content of the consignment at least partially based on the plausibility information and the data representing the content of the consignment. Also disclosed are embodiments of an apparatus for performing and/or controlling this method, a system with one or more such apparatuses, and a computer program for performing and/or controlling this method by a processor.

### CROSS-REFERENCE TO RELATED PATENT APPLICATION

This patent application claims priority to German Application No. 10 2016 125 503.3, filed Dec. 22, 2016, the entire teachings and disclosure of which are incorporated herein by reference thereto.

### FIELD

Exemplary embodiments relate to verifying the authenticity of the content of consignments, so that it is verifiable, in particular in an automated manner, whether the expected item is also actually contained in the consignment.

### BACKGROUND

In the example of consignments that are delivered by parcel services to their respective recipients, so far there has not been any possibility of authenticating the content of the respective consignment. On the one hand, for the respective recipients of the consignment there is only the possibility of verifying the content of the consignment with regard to the authenticity of the content after it arrives by opening the package. On the other hand, for return consignments in particular, there is no possibility of verifying whether the expected item is also actually contained in the package.

### BRIEF SUMMARY OF SOME EXEMPLARY EMBODIMENTS OF THE INVENTION

To be able to eliminate the possibility of misuse in this respect, it would be desirable to be able to provide a service for verifying the authenticity of the content of the consignments both for the respective recipients and for the acceptance of return consignments in particular.

There has not so far been any possibility of having such an authenticating service. In particular, generally no detection of the content of the consignment takes place, either at the time it is given up for delivery or at the time it is received at a station (acceptance point).

It would be desirable to be able to provide a service for verifying the authenticity of the content of consignments.

According to a first exemplary aspect, a method is disclosed, comprising the following:
gathering data of a consignment or obtaining gathered data of a consignment, the consignment being provided with at least one piece of information that enables determining of plausibility information indicative of a content to be authenticated of the consignment;
gathering data representing the content of the consignment or obtaining gathered data representing the content of the consignment;
generating a piece of authenticating information indicative of the authenticity of the content of the consignment at least partially based on the determined plausibility information and the gathered data representing the content of the consignment or outputting the determined plausibility information and the gathered data representing the content of the consignment for generating a piece of authenticating information.

In an exemplary embodiment of the first aspect, the method comprises obtaining the gathered data of the consignment, obtaining the gathered data representing the content of the consignment and outputting the plausibility information. In a further exemplary embodiment, the method comprises obtaining the gathered data of the consignment, gathering the data representing the content of the consignment and outputting the plausibility information. A further exemplary embodiment comprises gathering the data of the consignment, gathering the data representing the content of the consignment and generating the authenticating information. In another exemplary embodiment, the method comprises gathering the data of the consignment, obtaining the gathered data representing the content of the consignment and generating the authenticating information.

According to a second exemplary aspect, an apparatus is disclosed, configured for performing and/or controlling the method according to the first aspect, or comprising respective means for performing and/or controlling the steps of the method according to the first aspect. It is possible here that either all of the steps of the method are controlled, or all of the steps of the method are performed, or one or more steps are controlled and one or more steps are performed. One or more of the means may also be performed and/or controlled by the same entity and/or unit. For example, one or more of the means may be formed by one or more processors.

According to a third exemplary aspect, an apparatus is disclosed, comprising at least one processor and at least one memory, which includes program code, the memory and the program code being configured to make the at least one processor cause an apparatus (for example the apparatus with the processor and memory) perform and/or control at least the method according to the first aspect of the invention. It is possible here that either all of the steps of the method are controlled, all of the steps of the method are performed, or one or more steps are controlled and one or more steps are performed.

According to a fourth exemplary aspect, a system is disclosed, comprising one or more apparatuses which are configured for performing and/or controlling the method according to the first aspect or have means for performing and/or controlling the steps of the method according to the first aspect. It is possible here that either all of the steps of the method are controlled, or all of the steps of the method are performed, or one or more steps are controlled and one or more steps are performed.

According to a fifth exemplary aspect of the invention, a computer program is disclosed, comprising program instructions which cause a processor to perform and/or control the method according to the first aspect when the computer program runs on the processor. In this specification, a processor is intended to be understood as meaning inter alia control units, microprocessors, microcontrol units such as microcontrollers, digital signal processors (DSP), application-specific integrated circuits (ASICs) or field programmable gate arrays (FPGAs). It is possible here that either all of the steps of the method are controlled, or all of the steps of the method are performed, or one or more steps are performed, or one or more steps are controlled and one or more steps are performed. The computer program may be distributable, for example, by way of a network such as the Internet, a telephone or mobile radio network and/or a local area network. The computer program may be at least partially software and/or firmware of a processor. It may likewise be at least partially implemented as hardware. The computer program may be stored, for example, on a computer-readable storage medium, for example a magnetic, electrical, electro-magnetic, optical and/or other type of storage medium. The storage medium may be, for example, part of the processor, for example a (non-volatile or volatile) program memory of the processor or a part thereof. The storage medium is for example physical, that is to say tangible, and/or non-transitory.

These five aspects have, inter alia, the properties described below—some of which are given by way of example.

Data of a consignment are gathered or gathered data of a consignment are obtained. The consignment may be for example a large letter (which is used for example for sending books), an oversized letter (which is used for example for sending books or items of merchandise), a parcel or a package. However, other types of consignment are also conceivable. A large letter has for example the following dimensions: a length of 10-35.3 cm, a width of 7-25 cm, a height of up to 2 cm and a weight of up to 500 g. An oversized letter has for example the following dimensions: a length of 10-35.3 cm, a width of 7-25 cm, a height of up to 5 cm and a weight of up to 1000 g. A consignment may be in particular a letter with which books or items of merchandise are sent or a parcel or a package.

The consignment is provided with at least one piece of information that enables determining of plausibility information. For example, the gathered data of the consignment contain and/or represent this information. The data of the consignment are for example contained as information in a code printed on the consignment (for example on a label) or are contained in a readable memory connected to the consignment (for example contained therein or attached thereto), to name just a few possibilities. The data may for example follow a predefined format. In the case of a code printed onto the consignment, it may be for example a one-dimensional or two-dimensional barcode. Examples of a two-dimensional barcode are a QR code or a matrix code, for example a Data Matrix code.

Gathering the data of the consignment comprises for example mechanically reading out the data, for example from the code (for example by means of optical gathering) or the memory (for example by means of radio-based gathering, for example by technologies such as radio frequency identification (RFID) or near field communication (NFC)). Gathering the data of the consignment takes place by using means for gathering the data of the consignment that are for example part of the apparatus according to the invention or the system according to the invention. If the method according to the first aspect comprises obtaining gathered data of a consignment, the gathered data have for example been gathered in the way described above.

The data of the consignment may in particular be provided with at least one piece of information that enables determining of plausibility information. Correspondingly, the data of the consignment may in particular comprise an identification (in particular a unique identification) of the consignment, by means of which the consignment can be distinguished from other consignments (for example in a database). The identification may be for example a numeric or alphanumeric sequence. The data of the consignment may additionally or alternatively contain the following for example: an object key (which for example identifies the type of content to be authenticated), possibly combined with at least one feature of the object (for example an optical recognition feature of a product as content of the consignment, on the basis of which the content of the consignment is authenticatable). The data of the consignment may for example alternatively or additionally contain an object count (for example a plurality of identical products forms the content of the consignment, or a number of different products form the content of the consignment). In the case where at least two different objects form the content of the consignment, an object key, possibly combined with at least one feature of the object, may for example be contained in the data of the consignment for each of these types of content to be identified.

By means of the data of the consignment, plausibility information is determined. The plausibility information is indicative of a content to be authenticated of the consignment. For example, the plausibility information may comprise an object key (which for example identifies the type of content to be authenticated), possibly combined with at least one feature of the object (for example an optical recognition feature on the basis of which the content is authenticatable) and/or a parameter classifying a consignment that contains the object. Alternatively or additionally, the plausibility information may contain an object count (by analogy with the statements made above). Correspondingly, a determination of the plausibility information is performed on the basis of the data of the consignment. The object is for example a product, such as for example an item of merchandise. A determination of the plausibility information may be performed for example by an identification (in particular a unique identification) of the consignment that is comprised by the data of the consignment enabling inference of the plausibility information (for example by the identification, in particular a unique identification, being linked with corresponding plausibility information in a database).

Gathering the data representing the content of the consignment comprises for example machine gathering by using suitable means (for example a corresponding sensor system). The means for gathering the data representing the content of the consignment are for example part of the apparatus according to the invention or system according to the invention. If the method according to the first aspect comprises obtaining gathered data representing the content of the consignment, the gathered data have for example been gathered in the way described above. Data representing the content of the consignment are intended to be understood as meaning for example data characteristic of the content of the consignment, such as for example a value of a parameter classifying the consignment. The content of the consignment is intended to be understood as meaning in particular the actual content of the consignment.

At least partially based on the determined plausibility information and the gathered data representing the content of the consignment, a piece of authenticating information is generated (in particular automatically). Alternatively, the determined plausibility information and the gathered data representing the content of the consignment are output, in particular to an apparatus which is different from an apparatus that performs the gathering operations.

In an exemplary embodiment of the first aspect, the method may comprise the following: generating a piece of authenticating information indicative of the authenticity of the content of the consignment at least partially based on the determined plausibility information and the gathered data representing the content of the consignment, a probability regarding the authenticity of the content of the consignment being determined, based on a match between the determined plausibility information and the gathered data representing the content of the consignment.

The probability is determined for example by determining at least one match between the determined plausibility information and the gathered data representing the content of the consignment. For example, the determined match may be compared with a threshold value, there being for example a high probability of the (actual) content of the consignment being the expected (for example authentic) content if the threshold value is exceeded. The authenticating information is generated in accordance with the probability determined. For example, the probability determined may be output in addition to the determined plausibility information and the gathered data representing the content of the consignment for generating a piece of authenticating information.

At least on the basis of a comparison between the determined plausibility information and the gathered data representing the content of the consignment, a piece of authenticating information is generated (in particular automatically). The authenticating information is indicative of the authenticity (for example genuineness) of the content of the consignment. In the case of a positive comparison result of the comparison between the plausibility information and the gathered data representing the content of the consignment, the content of the consignment is for example authenticated, so that, at least with a high degree of probability, an expected object (for example product from a certain manufacturer) is also contained in the consignment.

In the case where an object key is comprised by the determined plausibility information, the comparison between this object key, possibly combined with at least one feature of the object, may be carried out for example with an object key or with the object key combined with at least one feature of the object of the gathered data representing the (actual) content of the consignment. The plausibility information may for example be available from an already authenticated content of a comparable consignment and be determined accordingly, so that it can be ensured by the aforementioned comparison whether or not the (actual) content is also the authentic (i.e. expected) content. In addition or alternatively, the comparison may comprise the object count that is determined based on the plausibility information and the corresponding object count that (actually) forms the content of the consignment and has been gathered according to the data representing the content of the consignment. If the method according to the first aspect comprises outputting the determined plausibility information and the gathered data representing the content of the consignment for generating a piece of plausibility information, the authenticating information can be generated for example on the basis of the information output (in particular automatically).

For example in the case of carrying out and/or controlling the method when a return consignment is concerned, the consignment (for example a package) may only be accepted (for example by a package station) if the (actual) content of the consignment has been positively authenticated on the basis of the authenticating information. In particular, the sender of the content of the consignment who is being returned the content by means of the return consignment thereby has an assurance that, at least with a high degree of probability, the (actual) content of the consignment is the content to be authenticated (that is to say the expected content). The same applies to the case where the method is carried out and/or controlled when delivering the consignment to a recipient of the consignment. On the basis of the authenticating information generated, the recipient can become aware that, at least with a high degree of probability, the (actual) content of the consignment corresponds to the content to be authenticated (that is to say the actually expected content). In this way, a service for verifying the authenticity of the content of consignments—an authenticating service—can be provided.

According to an exemplary embodiment of all aspects, the plausibility information and the data representing the content of the consignment are indicative of at least one of the following parameters classifying the content of the consignment: (i) weight of the content of the consignment; (ii) size of the content of the consignment; (iii) chemical composition of the content of the consignment; (iv) optical features of the content of the consignment; (v) object identification of the content of the consignment; (vi) brand identification of the content of the consignment; (vii) product identification of the content of the consignment; (viii) number of objects of the content of the consignment; (ix) barcode comprised by the content of the consignment; (x) magnetism of the content of the consignment; (xi) or a combination thereof.

The plausibility information is indicative of at least one parameter classifying the content of the consignment, the plausibility information being based for example on an (already) authenticated content of a consignment. The plausibility information is alternatively or additionally provided for example by the sender of the content of the consignment. The corresponding parameters classifying the content of the consignment have for example already been determined at an earlier time (for example on the basis of an identical content of one or more consignments that one or more customers have already sent before, for example as a return).

The data representing the content of the consignment are indicative of at least one parameter classifying the content of the consignment, the actual content of the consignment being determined for this in the course of gathering data or obtaining the gathered data representing the content of the consignment. For example, the data representing the content of the consignment are indicative of a value of at least one parameter classifying the content of the consignment (for example these data contain such a value).

The chemical composition of the content of the consignment may for example be a measured variable that can be detected from outside (for example by means of a chemical sensor). For example, the chemical composition may be detected by means of electrochemical means of analysis that can detect biochemical components of the content of the consignment (for example glucose, cholesterol, lactate and/or alcohol components that are included in the content of the consignment).

An optical feature of the content of the consignment may be for example a certain color (for example of part) of the content. A further optical feature may be for example a reflective property of the content of the consignment. For example, a significant feature, for example the shape or color of the content of the consignment, may be an optical feature.

The object identification of the content of the consignment may be enabled for example by an identification of the type of content (for example a certain item of merchandise).

The brand identification of the content of the consignment may be enabled for example by way of an identification arranged on the content of the consignment (for example an imprint of a brand logo or the like).

By contrast with the object identification, the product identification of the content of the consignment may comprise the identification of the content of the consignment by an assignment to a certain manufacturer.

A barcode that is comprised by the content of the consignment (for example printed on the content of the consignment) may for example, as identification, enable identification of the content of the consignment as being of a particular object, brand and/or product. In addition or alternatively, apart from these parameters, it is also possible for example for the weight, the size, the chemical composition or the magnetism to be determined by means of the barcode (for example by making a corresponding inquiry in a database).

The magnetism of the content of the consignment may for example be a binary parameter that is indicative of whether or not the content of the consignment is magnetic. In addition or alternatively, the magnetism parameter may for example indicate a magnetic field strength that the content of the consignment has.

According to an exemplary embodiment of all aspects, in the course of the comparison at least one parameter of the plausibility information classifying the content of the consignment is compared with a corresponding parameter of the gathered data representing the content of the consignment.

According to an exemplary embodiment of all aspects, the data representing the content of the consignment are gathered by at least one sensor.

By means of the at least one sensor it is possible for example to gather the data of the consignment (for example the information that enables determining of plausibility information) and/or the data representing the content of the consignment indicative of at least one parameter classifying the content of the consignment. The at least one sensor may for example be comprised by an apparatus according to the invention and/or by a system according to the invention. In one configuration, for example, one or more sensors may be coupled to one another, in order in particular to be able to gather one or more different pieces of plausibility information and the data representing the content of the consignment indicative of at least one parameter classifying the content of the consignment. For example, the data representing the content of the consignment contain a value gathered by a sensor for the consignment and/or the content of the consignment. The value represents for example at least parameters classifying a content of the consignment.

For detecting a weight of the content of the consignment, a weight sensor (for example a force sensor) may be used in particular. By means of the weight sensor, the weight of the content of the consignment can be determined for example by way of the force acting on the weight sensor.

For detecting the size of the content of the consignment, an optical sensor may be used for example. The optical sensor is, for example, a camera-like element with which a piece of image information can be gathered. The image information is evaluable, for example by using evaluating means (for example an evaluating unit), so that for example the size of the content of the consignment can be determined. An optical sensor of the aforementioned type (in particular as a camera-like element) may for example additionally or alternatively enable gathering of at least one optical feature of the content of the consignment, an object identification of the content of the consignment, a brand identification of the content of the consignment, a product identification of the content of the consignment, a number of objects of the content of the consignment, a barcode or a combination thereof.

In the case of gathering a barcode by means of an optical sensor, it is possible in particular to gather an identification provided on the consignment or on the content of the consignment (for example an EAN code (EAN: European Article Number) and/or a GS1 code (GS1: Global Standards One)). For example, these pieces of further information can be determined by making an inquiry in a database in which further information about the identification is stored, for example referring to parameters classifying the content of the consignment.

For detecting a chemical composition, it is possible in particular to use a microfluidic sensor, which can in particular detect an electrochemical analysis of for example biochemical components and/or substances and/or compositions of substances.

For detecting a magnetism, it is possible for example to use a microelectromechanical sensor (MEMS: microelectromechanical sensor). A microelectromechanical sensor enables detection of a magnetism that is present and/or a magnetic field that is present and/or to detect the field strength of a magnetic field.

According to an exemplary configuration of all aspects, the at least one piece of information of the consignment comprises a piece of reference information, which is in particular linked and/or associated with plausibility information stored in a database. The reference information is for example comprised by the data of the consignment. The reference information is for example a piece of electronic data interchange (EDI) information, which enables for example a digital data exchange between a customer and a transport company commissioned with transporting the consignment. The reference information is for example a piece of pre-advice-notification (PAN) information. The reference information enables in particular a clear identification of the consignment.

An exemplary configuration according to all aspects provides that the plausibility information stored in the database is stored in a form in which it is signed by at least one trustworthy third party. For example, there may be a trusted link between for example a server and an apparatus according to the invention and/or an apparatus of a system according to the invention, it being possible for this trusted link to be built up for example on the basis of an exchange of certificates and/or public cryptographic keys. It can correspondingly be ensured that the plausibility information stored in the database is trustworthy and/or authenticated. The exchangeable certificates and/or public cryptographic keys represent for example master data of a web shop and/or of third parties whose identity in particular has been verified (for example by a preceding verification process, for example by means of an exchange of at least one certificate and/or at least one public cryptographic key).

According to an exemplary configuration, it is provided that the gathering of data representing the content of the consignment is enabled by means of an accepting unit and/or an outputting unit. The accepting unit and/or the outputting unit is for example comprised by a receiving unit (for example of a station (package station)) and/or by a scanner (for example of an agent delivering the consignment)). In particular, the gathering and/or generating operations according to all aspects of the invention are possible by means of the accepting unit and/or the outputting unit.

According to an exemplary configuration, the at least one sensor is integrated in the accepting unit and/or the outputting unit.

In an exemplary configuration according to all aspects, the method also comprises:—storing gathered data representing the content of the consignment as plausibility information in a database.

In an exemplary configuration, a plurality of gathered data representing the content of the consignment are stored as plausibility information in a data record of plausibility information.

The database stores for example a plurality of pieces of plausibility information. A number of pieces of plausibility information concerning a content of a consignment may for example be compiled in a data record specific to the consignment. Each piece of plausibility information is for example assigned to a respective content of a consignment. In relation to this content of the consignment, the respective piece of plausibility information contains at least one piece of information (for example a parameter classifying the content of the consignment). A respective piece of plausibility information is for example linked and/or associated with a piece of reference information (for example an identification) of the consignment. This reference information may for example also be contained in the data of the consignment that are gathered in the gathering operations according to all aspects. If, therefore, data of a consignment are gathered at a station (for example a package station) or when delivering the consignment (for example by a scanner), it is possible at least on the basis of the data gathered (in particular the identification of the consignment) to determine a piece of plausibility information, the plausibility information comprising for example the weight, the size, at least one optical feature, the number of objects, a barcode of the content of the consignment, or a combination thereof. The database may for example be a central database, information stored in the database being retrievable for example by way of a communication network.

According to an exemplary configuration according to all aspects, the method also comprises at least one of the following method steps:
determining a piece of heuristic analysis information on the basis of the gathered data representing the content of the consignment;
generating a piece of test specification information indicative of manually authenticating the content of the consignment or outputting the determined heuristic analysis information for generating a piece of test specification information.

The gathered data representing the content of the consignment are used for determining the heuristic analysis information. For example, in addition or alternatively, the gathered data of the consignment may be used for determining the heuristic analysis information. The heuristic analysis information may for example be determined on the basis of generating statistics concerning the gathered data representing the content of the consignment. Additionally, further information comprised by the data of the consignment, such as for example the location (of accepting the consignment or giving up the consignment for delivery), the time, the content of the consignment, the sender, the recipient, or a combination thereof may be taken into consideration when determining the heuristic analysis information.

The heuristic analysis information is for example indicative of a content of the consignment that is sometimes negatively authenticatable. Correspondingly, the heuristic analysis information is therefore indicative of whether or not, with a certain probability (for example predefined on the basis of a threshold value to be exceeded), the content of the consignment is the actually expected content. On this basis, the test specification information is generated, comprising for example a specification of action to be taken by a person (for example an employee of a station (for example package station) or a delivery agent) to allow the content of the consignment to be authenticated. For example, it is determinable by means of a certain verification of the content whether the content of the consignment is genuine, or is for example an imitation.

On the basis of the heuristic analysis information, a piece of test specification information is generated. In particular, a piece of test specification information is generated in the event that the determined heuristic analysis information calls into question the authenticity of the content of the consignment. This is for example the case whenever, with a certain probability, the content of the consignment is not the actually expected content. For this, a comparison of a calculated probability on the basis of the heuristic analysis information with a predefined threshold value may for example be comprised by the method. If the predefined threshold value is exceeded, the heuristic analysis information may correspondingly be indicative of the fact that the content of the consignment does not correspond to the actually expected content of the consignment.

In an exemplary configuration according to all aspects of the invention, the test specification information is stored in a database. The test specification information is for example—by analogy with the plausibility information—linked and/or associated with a piece of reference information (for example an identification) of the consignment. The database may for example be a central database, information stored in the database being retrievable for example by way of a communication network. The test specification information may be stored in the same database as the plausibility information.

According to an exemplary embodiment of all aspects, the method also comprises gathering a user input or obtaining a gathered user input when the test specification information is available. The user input may for example be input by a person with or without using aids. For example, a user interface may be used for the input of the test specification information. The user interface may for example be an input apparatus (for example a touchpad, touch-sensitive display or the like), by means of which an input by the user (for example a person) can be gathered. The user input may be performed for example in the event that the test specification information has been verified (for example by a person). In particular, the person is able to decide whether or not there is the requirement predetermined by the test specification information to authenticate (for example an optical feature) of the content of the consignment. In accordance with this decision, the user input can for example confirm or deny the authenticity of the content of the consignment.

The embodiments and exemplary configurations of all aspects that are described above, and in the first instance are in principle independent on their own, are also intended to be understood in all combinations with one another.

Further advantageous exemplary configurations can be taken from the following more detailed description of some exemplary embodiments, in particular in conjunction with the figures. The figures accompanying the application are only intended, however, for the purpose of illustration, and do not serve for determining the protective scope of the invention. The accompanying drawings are not necessarily to scale and are merely intended to reflect the general concept by way of example. In particular, features that are contained in the figures are not in any way intended to be regarded as absolutely necessary constituents.

### BRIEF DESCRIPTION OF THE SEVERAL VIEWS OF THE DRAWING

In the figures:

FIG. 1 shows a schematic representation of an exemplary embodiment of a system according to the fourth aspect;

FIG. 2 shows a flow diagram of an exemplary configuration of a method according to the first aspect;

FIG. 3 shows a flow diagram of an exemplary configuration of a method according to the first aspect; and

FIG. 4 shows a schematic representation of an exemplary embodiment of an apparatus according to the second or third aspect.

### DETAILED DESCRIPTION OF SOME EXEMPLARY EMBODIMENTS OF THE INVENTION

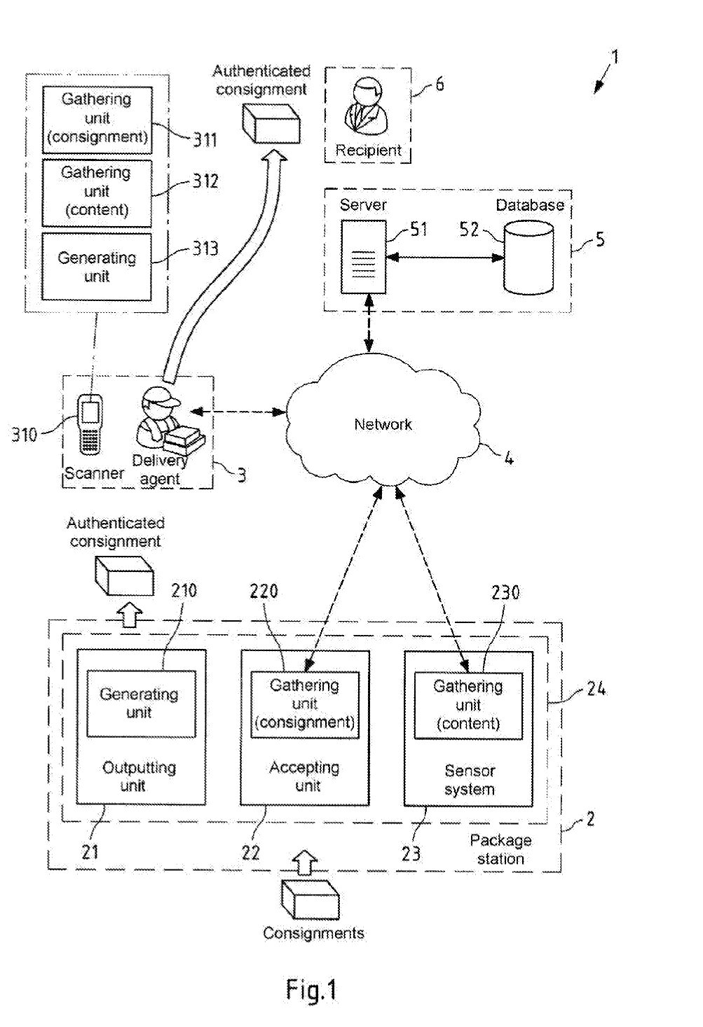

FIG. 1 is a schematic representation of an exemplary embodiment of a system 1 according to the present invention. The system 1 comprises a package station 2, a delivery agent 3, a network 4, a central computing and storing unit 5 and a recipient 6. The wide arrows symbolize here the regular flow of consignments that are received by a sender (for example at the package station 2) and given up for delivery to a recipient (for example recipient 6). The dashed arrows symbolize the exchange of information on the basis of the various components of the system 1.

The package station 2 comprises a receiving unit 24, which in turn comprises an outputting unit 21, an accepting unit 22 and a sensor system 23. Although the outputting unit 21, the accepting unit 22 and the sensor system 23 are represented in FIG. 1 by way of example as dedicated components, they are alternatively or additionally integrated in one unit.

The package station 2 comprises a generating unit 210, in FIG. 1 comprised by the outputting unit 21. The package station 2 comprises a gathering unit (consignment) 220, in FIG. 1 comprised by the accepting unit 22. The package station 2 comprises a gathering unit (content) 230, in FIG. 1 comprised by the sensor system 23. The generating unit 210, the gathering unit (consignment) 220, and the gathering unit (content) 230 are alternatively integrated in one unit.

The delivery agent 3 has in the present case a scanner 310. By analogy with the accepting unit 24, the scanner 310 comprises a gathering unit (consignment) 311, a gathering unit (content) 312 and a generating unit 313. In the present case, the gathering unit (consignment) 311, the gathering unit (content) 312 and the generating unit 313 are integrated in the scanner 310; alternatively, at least one of the components, gathering unit (consignment) 311, gathering unit (content) 312 and generating unit 313, is configured and/or designed as a dedicated component.

The central computing and storing unit 5 comprises a server 51 and a database 52. The server 51 and the database 52 are alternatively or additionally separate from one another and connected to one another by way of a communication connection for the exchange of data. In an alternative configuration, the server 51 and the database 52 are configured together in one unit.

The package station 2, the delivery agent 3, and the central computing and storing unit 5 are connected to one another by way of the network 4. Correspondingly, the package station 2, the delivery agent 3, the central computing and storing unit 5 can for example set up communication connections with one another for the exchange of data and use them correspondingly.

In an exemplary embodiment, for example, a person would like to send a return consignment. The person therefore comes into a station (for example package station 2) with an (unclosed) package. An employee at the station gathers data of the return consignment, for example a piece of reference information (for example an identification printed on the consignment or comprised by the consignment (for example an ID, a barcode or the like)). The gathering of the reference information may be performed for example with the accepting unit 22, which comprises the gathering unit 220 (for example respectively comprised by the receiving unit 24). The gathering unit 220 may for example have a corresponding sensor system, such as for example at least one sensor, or the at least one sensor may be integrated in the gathering unit 220. Alternatively or additionally, the gathering unit 230 of the sensor system 23, respectively comprised by the receiving unit 24, may also be used for the gathering. The gathering unit 230 has a sensor system, such as for example at least one sensor, with which gathering of data of the consignment, in the present case the return consignment, is possible.

For example by making an inquiry in the database 52, which is for example sent to the server 51 by way of the communication network 4, the receiving unit 24 determines plausibility information that is indicative of a content to be authenticated of the consignment. For example, the plausibility information may have been stored in the database when a consignment with a comparable content was sent at an earlier time (for example by a different person). In addition or alternatively, the plausibility information may have been stored in the database 52 by the sender of the content of the return consignment (which was for example acquired by the person in the course of an on-line purchase). The plausibility information comprises for example ‘target data’ for the content of the consignment, for example a size, an optical feature, the number of items, etc.

This is followed by gathering data representing the content of the consignment, for example by means of the gathering unit 230 of the sensor system 23. Since the return consignment to be sent is an unclosed consignment, the actual content (‘actual data’) can be gathered by means of the sensor system 23. As already stated, the gathering unit 230 of the sensor system 23 has for example at least one sensor, for example an optical sensor, so that for example a piece of image information of the actual content of the consignment can be gathered. The image information may for example be evaluated by an evaluating unit (not represented) comprised by the receiving unit 24, in order for example to gather the size, at least one optical feature, the number of objects, or the like etc. of the content of the return consignment. A corresponding evaluating unit may also be implemented for example on a server, for example server 51, the gathered image information being sent for example along with an inquiry for the evaluation of the image information by way of the network 4 to the server (for example server 51). After the evaluation of the image information, for example at least one parameter classifying the content of the consignment is sent back as a reply, which is received by the receiving unit 24. The parameter is in this case for example indicative of the size, at least one optical feature, the number of objects, or further parameters of the content of the consignment that are cited within this specification.

There may optionally be a heuristic test, involving determination of heuristic analysis information. If this heuristic test finds for example that there have recently been frequent cases of fraud in the return of identical contents of the consignment, a piece of test specification information may for example be generated. The test specification information may for example be shown on a display apparatus (not represented) of the receiving unit 24. The test specification information may for example include a request to an employee at the package station 2, asking the employee to verify manually the authenticity of the content of the return consignment. If for example the content of the return consignment is a smartphone, and the cases of fraud relate for example to removed smartphone batteries, the test specification information may for example ask the employee to switch on the smartphone in order to ensure that the battery of the smartphone has not been removed. This may be followed by gathering a user input, which is for example indicative of successful verification with regard to the test specification information.

Subsequently, a piece of authenticating information is generated. For this purpose, a comparison is carried out between the determined plausibility information and the gathered data representing the content of the consignment. On the basis of this result, optionally along with the ‘heuristic test’, the authenticating information is generated. In the case of a successful verification of the authenticity of the content of the return consignment, the return consignment is finally accepted at the package station 2. The return consignment is closed and the sender (customer surrendering the return consignment) is for example given a receipt. In the event that the authenticity of the content of the consignment cannot be confirmed, it is possible for example for acceptance already to be refused and, correspondingly, the original sender of the content of the consignment to be notified.

The authenticated consignment leaves the package station 2 to be transported, and is passed on to a delivery agent 3 for taking the consignment to a recipient 6.

The verification described above of the authenticity of the content of a consignment (carried out when it is received at the package shop) may also be performed analogously when the consignment is delivered to a recipient.

For this purpose, a scanner 310 of the delivery agent 3 may for example be configured with a gathering unit 311 and/or 312, and a generating unit 313.

With the gathering unit 311 it is possible for example to gather data of the consignment, for example a piece of reference information (for example an identification printed on the consignment or comprised by the consignment (for example an ID, a barcode or the like)). The gathering unit 311 may for example have a corresponding sensor system, such as for example at least one sensor, or the at least one sensor may be integrated in the gathering unit 311 of the scanner 310. Alternatively or additionally, the gathering unit 312, comprised by the scanner 310, may also be used for the gathering. The gathering unit 312 has a sensor system, such as for example at least one sensor, with which gathering of data of the consignment, in the present case the consignment to be delivered, is possible.

For example by making an inquiry in the database 52, which is for example sent to the server 51 by way of the communication network 4, the scanner 310 determines plausibility information that is indicative of a content to be authenticated of the consignment. For example, the plausibility information may have been stored in the database when a consignment with a comparable content was sent at an earlier time (for example by a different person). In addition or alternatively, the plausibility information has been stored in the database 52 by the sender of the content of the consignment (which was for example acquired by the recipient 6 in the course of an on-line purchase). The plausibility information comprises for example ‘target data’ for the content of the consignment, for example a size, at least one optical feature, the number of objects, or similar parameters classifying the content of the consignment.

The recipient can open the consignment and, for example by means of the gathering unit 312, which for example comprises at least one sensor (for example an optical sensor), a piece of image information of the content of the consignment can be gathered (‘actual data’).

The image information may for example be evaluated by an evaluating unit (not represented) comprised by the scanner 310, in order for example to gather the size, at least one optical feature, the number of items, etc. of the content of the consignment. A corresponding evaluating unit may also be implemented for example on a server, for example server 51, the gathered image information being sent for example along with an inquiry for the evaluation of the image information by way of the network 4 to the server. After the evaluation of the image information, for example these parameters classifying the content of the consignment are sent back as a reply, which is received by the scanner 24.

As already stated in conjunction with the reception of a return consignment, on the basis of a comparison between the determined plausibility information and the gathered data representing the content of the consignment, a piece of authenticating information can be generated. The recipient 6 of the consignment thereby obtains a verification that the content of the consignment is also the actually expected content. Should the authenticating information call into question the authenticity of the content of the consignment, the recipient 6 may for example decline to accept the consignment.

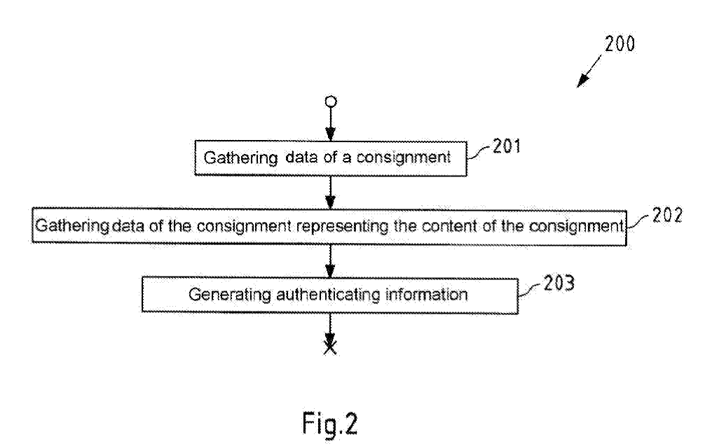

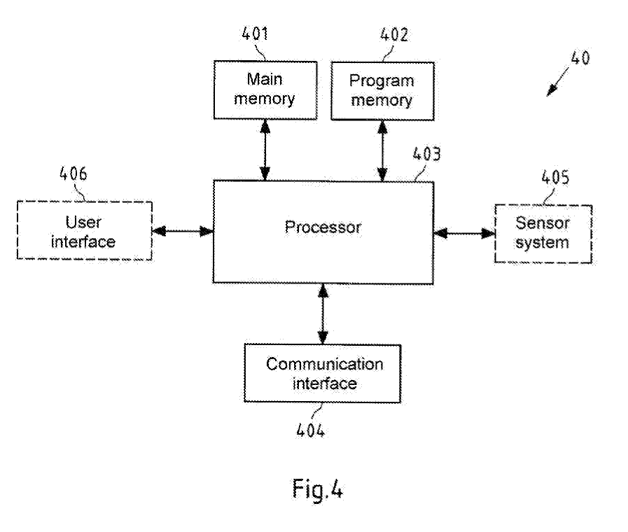

FIG. 2 shows a flow diagram 200 of an exemplary embodiment of a method according to the first aspect. The method is performed for example by the receiving unit 24 and/or the scanner 310 of FIG. 1, which can be respectively formed for example as apparatus 40 according to FIG. 4.

In a first step 201, data of a consignment are gathered. The consignment is provided with at least one piece of information that enables determining of plausibility information. For example, the gathered data contain and/or represent the information with which the consignment is provided and which enables determining of plausibility information. Plausibility information is indicative of a content to be authenticated of the consignment.

In a second step 202, data representing the content of the consignment are gathered.

In a third step, a piece of authenticating information is generated. The authenticating information is indicative of the authenticity, i.e. for example the genuineness, of the content of the consignment. On the basis of a comparison, in which the determined plausibility information is compared with the gathered data representing the content of the consignment, the authenticating information is generated. If the comparison has a positive outcome, the authenticating information comprises in particular at least a part that is representative of the content of the consignment being authenticated. If the comparison has a negative outcome, the authenticating information comprises in particular at least a part that is representative of the authentication of the content of the consignment failing, or of the fact that the content of the consignment could not be authenticated.

In order to verify the content of a further consignment, as to whether its content corresponds to an expected content, in the present exemplary embodiment the flow diagram 200 can be performed once again.

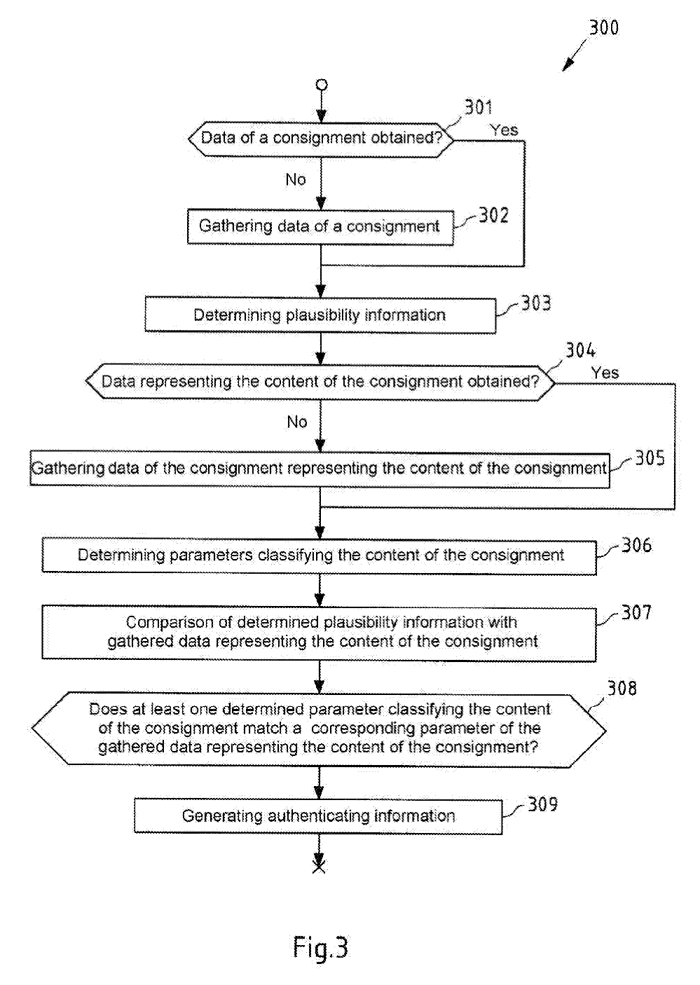

FIG. 3 shows a flow diagram 300 of an exemplary embodiment of a method according to the first aspect. The method is performed for example by the receiving unit 24 and/or the scanner 310 of FIG. 1, which can be respectively formed for example as apparatus 40 according to FIG. 4.

In step 301, it is verified whether data of a consignment have been obtained. These are gathered data of a consignment that have been gathered from a consignment which is provided with at least one piece of information. The gathered data which can be obtained in step 301 enable determining of plausibility information. In the event that no such data of a consignment have been obtained, in step 302 the data of a consignment are gathered.

The obtained data of a consignment (step 301) or the gathered data of a consignment (step 302) are used in step 303 for determining plausibility information. The plausibility information is indicative of a content to be authenticated of the consignment. For example, the gathered data of the consignment comprise a piece of reference information, by means of which an inquiry can be made in a database, for example database 52 according to FIG. 1. In the database, plausibility information concerning the content of the consignment is for example linked and/or associated with the reference information. Correspondingly, this inquiry in the database may for example enable determining of the plausibility information.

In step 304, it is verified whether data representing the content of the consignment have been obtained. These are gathered data representing the content of the consignment. In the event that no data representing the content of the consignment have been obtained, in step 304 gathering of data representing the content of the consignment is carried out. The data obtained in step 304 or gathered in step 305 representing the content of the consignment are used in step 306 for determining parameters classifying the content of the consignment. The parameters classifying the content of the consignment are gathered on the basis of the actual content of the consignment.

In step 307, a comparison between the at least one determined piece of plausibility information and the gathered data representing the content of the consignment is carried out. This involves for example a parameter classifying the content of the consignment of the plausibility information (for example the weight and color of the content) being compared with the corresponding parameter classifying the content of the consignment of the gathered data representing the content of the consignment. A comparison therefore takes place between a kind of ‘target value’ (plausibility information) and a kind of ‘actual value’ (gathered data representing the content of the consignment). If the values to be compared deviate from one another, in that for example a predetermined threshold value that defines an admissible degree of deviation, is exceeded, it is possible that the actual content of the consignment does not correspond to the expected, i.e. authentic content of the consignment. In this event, optionally (and therefore not represented in the flow diagram 300) a piece of test specification information that can for example be verified by a person (for example the delivery agent 3 according to FIG. 1) may be generated. The manual verification by the person can allow a final assessment as to whether the content of the consignment is authentic, i.e. for example is genuine and not an imitation or modification. This is verified by step 308.

In step 309, a piece of authenticating information is generated. The authenticating information is generated on the basis of the result of the comparison of step 307, 308.

In order to verify the content of a further consignment, as to whether its content corresponds to an expected content, in the present exemplary embodiment the flow diagram 300 can be performed once again.

The sequence of the method steps 301 to 309 indicated according to the flow diagram 300 is merely by way of example and not obligatory. Whenever appropriate, the sequence of the method steps may be changed, while verification of the authenticity of the content of a consignment continues to be possible.

FIG. 4 shows a schematic representation of an exemplary embodiment of an apparatus 40 that can be used in the context of the present invention.

The apparatus 40 may for example represent the gathering unit 220 of the accepting unit 22, the gathering unit 230 of the sensor system 23, or the gathering unit 311 or 312 of the scanner 310 of FIG. 1. The apparatus 40 may for example represent the generating unit 210 of the outputting unit 21, or the generating unit 313 of the scanner 310 of FIG. 1. The apparatus 40 may for example represent the receiving unit 24 according to FIG. 1.

The apparatus 40 may for example perform the flow diagram 200 of FIG. 2 or 300 of FIG. 3.

The apparatus 40 comprises a processor 403 with an assigned main memory 401 and program memory 402. The processor 403 performs for example program instructions that are stored in the program memory 402. The program instructions perform the method according to the first aspect and/or control it. Consequently, the program memory 402 contains a computer program according to the fifth aspect and represents a computer program product for storing it. The apparatus 40 represents an example of an apparatus according to the second aspect or an apparatus of a system according to the third aspect.

The program memory 402 may be for example a persistent memory, such as for example a read-only memory (ROM). The program memory 402 may for example be permanently connected to the processor 403, but may alternatively also be detachably connected to the processor 403, for example as a memory card, floppy disk or optical data carrier medium (for example a CD or DVD). Further information may also be stored in the program memory 402, or in a separate memory.

The main memory 401 is used for example for storing temporary results during the processing of the program instructions; this is for example a volatile memory, such as for example a random-access memory (RAM).

Processor 403 is also operatively connected to a communication interface 404, with which for example an information exchange with other apparatuses is possible (see for example the dashed arrows in FIG. 1).

The apparatus 40 may contain further components. If the apparatus 40 represents the gathering unit 220, 230 or 311, 312, there is provided in particular a sensor system 405, which is configured for example for the optical gathering (for example in the form of a scanner) of the data of a consignment or the data of the content of the consignment and is operatively connected to the processor 403.

If the apparatus 40 represents the gathering unit 220, 230, 311, 312, the sensor system 405 may for example comprise at least one sensor. The sensor system is in particular configured to gather the plausibility information and the data representing the content of the consignment indicative of at least one parameter classifying the content of the consignment.

If the apparatus 40 represents the generating unit 210 or 313, there may be means for generating a piece of authenticating information that are operatively connected to the processor 403. These means may for example be configured for comparing determined plausibility information with gathered data representing the content of a consignment.

Optionally, the apparatus 40 may have a user interface 406, by means of which for example it is possible for information to be shown (for example shown optically). For example, the user interface is a display apparatus (for example a liquid crystal display (LCD), or a light emitting diode (LED) display or the like).

The exemplary embodiments which are described in this specification are intended to be understood as having been disclosed both individually and in all combinations with one another. In particular, the description of a feature included in one embodiment—unless explicitly stated to the contrary—is also not intended to be understood in the present case as meaning that the feature is indispensable or essential to the function of the exemplary embodiment. The sequence of the method steps described in this specification in the individual flow diagrams is not obligatory and alternative sequences of the method steps are conceivable. The method steps can be implemented in various ways, and so an implementation in software (by means of program instructions), hardware or a combination of both is conceivable for implementing the method steps. Terms such as “comprise”, “have”, “include”, “contain” and the like used in the patent claims do not exclude further elements or steps. The wording “at least partially” includes both the case of “partially” and the case of “completely”. The wording “and/or” is intended to be understood as meaning that both the alternative and the combination are intended to have been disclosed, that is to say “A and/or B” means “(A) or (B) or (A and B)”. A plurality of units, persons or the like means multiple units, persons or the like in connection with this specification. The use of the indefinite article does not exclude a plurality. An individual unit may perform the functions of a plurality of units or units mentioned in the patent claims. Reference symbols stated in the patent claims should not be considered as restrictions of the means and steps used.

1. Method, comprising:
gathering data of a consignment or obtaining gathered data of a consignment, the consignment being provided with at least one piece of information that enables a determining of plausibility information indicative of a content to be authenticated of the consignment;
gathering data representing the content of the consignment or obtaining gathered data representing the content of the consignment;
generating a piece of authenticating information indicative of the authenticity of the content of the consignment at least partially based on the determined plausibility information and the gathered data representing the content of the consignment or outputting the determined plausibility information and the gathered data representing the content of the consignment for generating a piece of authenticating information.

2. Method according to claim 1, wherein the plausibility information and the data representing the content of the consignment are indicative of at least one of the following parameters classifying the content of the consignment:
weight of the content of the consignment;
size of the content of the consignment;
chemical composition of the content of the consignment;
optical features of the content of the consignment;
object identification of the content of the consignment;
brand identification of the content of the consignment;
product identification of the content of the consignment;
number of objects of the content of the consignment;
barcode comprised by the content of the consignment;
magnetism of the content of the consignment;
or a combination thereof.

3. Method according to claim 2, wherein in the course of the comparison at least one parameter of the plausibility information classifying the content of the consignment is compared with a corresponding parameter of the gathered data representing the content of the consignment.

4. Method according to claim 1, wherein the data representing the content of the consignment are gathered by at least one sensor.

5. Method according to claim 1, wherein the at least one piece of information of the consignment comprises a piece of reference information, which is in particular linked and/or associated with plausibility information stored in a database.

6. Method according to claim 5, wherein the plausibility information stored in the database is stored in a form in which it is signed by at least one trustworthy third party.

7. Method according to claim 1, wherein the gathering of data representing the content of the consignment is enabled by means of an accepting unit and/or an outputting unit, wherein the at least one sensor is integrated in the accepting unit and/or outputting unit.

8. Method according to claim 1, the method comprising:
storing gathered data representing the content of the consignment as plausibility information in a database.

9. Method according to claim 8, wherein a plurality of gathered data representing the content of the consignment are stored as plausibility information in a data record of plausibility information.

10. Method according to claim 1, the method comprising:
determining a piece of heuristic analysis information based on gathered data representing the content of the consignment;
generating a piece of test specification information indicative of manually authenticating the content of the consignment or outputting the determined heuristic analysis information for generating a piece of test specification information.

11. Apparatus comprising at least one processor and at least one memory including computer program code, the at least one memory and the computer program code configured to, with the at least one processor, cause the apparatus to at least perform:
gathering data of a consignment or obtaining gathered data of a consignment, the consignment being provided with at least one piece of information that enables a determining of plausibility information indicative of a content to be authenticated of the consignment;
gathering data representing the content of the consignment or obtaining gathered data representing the content of the consignment;
generating a piece of authenticating information indicative of the authenticity of the content of the consignment at least partially based on the determined plausibility information and the gathered data representing the content of the consignment or outputting the determined plausibility information and the gathered data representing the content of the consignment for generating a piece of authenticating information.

12. Apparatus according to claim 11, wherein the plausibility information and the data representing the content of the consignment are indicative of at least one of the following parameters classifying the content of the consignment:
weight of the content of the consignment;
size of the content of the consignment;
chemical composition of the content of the consignment;
optical features of the content of the consignment;
object identification of the content of the consignment;
brand identification of the content of the consignment;
product identification of the content of the consignment;
number of objects of the content of the consignment;
barcode comprised by the content of the consignment;
magnetism of the content of the consignment;
or a combination thereof.

13. Apparatus according to claim 12, wherein in the course of the comparison at least one parameter of the plausibility information classifying the content of the consignment is compared with a corresponding parameter of the gathered data representing the content of the consignment.

14. Apparatus according to claim 11, wherein the data representing the content of the consignment are gathered by at least one sensor.

15. Apparatus according to claim 11, wherein the at least one piece of information of the consignment comprises a piece of reference information, which is in particular linked and/or associated with plausibility information stored in a database.

16. Apparatus according to claim 15, wherein the plausibility information stored in the database is stored in a form in which it is signed by at least one trustworthy third party.

17. Apparatus according to claim 11, wherein the gathering of data representing the content of the consignment is enabled by means of an accepting unit and/or an outputting unit, wherein the at least one sensor is integrated in the accepting unit and/or outputting unit.

18. Apparatus according to claim 11, the at least one memory and the computer program code configured to, with the at least one processor, cause the apparatus further to perform:
storing gathered data representing the content of the consignment as plausibility information in a database.

19. Apparatus according to claim 8, wherein a plurality of gathered data representing the content of the consignment are stored as plausibility information in a data record of plausibility information.

20. Apparatus according to claim 1, the at least one memory and the computer program code configured to, with the at least one processor, cause the apparatus further to perform:
determining a piece of heuristic analysis information based on gathered data representing the content of the consignment;
generating a piece of test specification information indicative of manually authenticating the content of the consignment or outputting the determined heuristic analysis information for generating a piece of test specification information.

21. A tangible computer-readable medium storing computer program code, the computer program code when executed by a processor causing an apparatus to perform and/or control:
gathering data of a consignment or obtaining gathered data of a consignment, the consignment being provided with at least one piece of information that enables a determining of plausibility information indicative of a content to be authenticated of the consignment;
gathering data representing the content of the consignment or obtaining gathered data representing the content of the consignment;
generating a piece of authenticating information indicative of the authenticity of the content of the consignment at least partially based on the determined plausibility information and the gathered data representing the content of the consignment or outputting the determined plausibility information and the gathered data representing the content of the consignment for generating a piece of authenticating information.
